(19) United States
(12) Patent Application Publication
(10) Pub. No.: US 2005/0086787 A1
(43) Pub. Date: Apr. 28, 2005

(54) Method for manufactuirng a case and product thereof

(75) Inventors: Sunjeen Choe, Fullerton, CA (US); Eric S. Choe, Fullerton, CA (US)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: Sunjeen, Inc.

(21) Appl. No.: 10/692,540

(22) Filed: Oct. 24, 2003

(51) Int. Cl. A45C 11/00; B23P 25/00

(52) U.S. Cl. 29/458; 29/527.2; 206/314

(57) ABSTRACT

The present invention provides a method for manufacturing a case and a product thereof. The steps for manufacturing a case include inserting an adhesive between a stack of sheets; compressing the stack of sheets; heat-molding the stack of sheets to form sidewalls and panels; and heating the stack of sheets using radio frequency radiation.

### BACKGROUND

1. Field of the Invention

The present invention relates to a method for manufacturing a case and a product thereof, and more particularly, to a method for manufacturing a case for musical instruments.

2. Description of Related Art

Generally, a method for manufacturing cases can be simply described as using a plurality of panels to create a container. Certain cases utilize sheets of various types of material, which are laminated to provide additional rigidity to protect the contents therein. Furthermore, such cases often include wooden sheets.

Currently, cases for musical instruments primarily utilize sheets of wood that are laminated with adhesives. These cases feature panels that comprise of laminated sheets of wood that are initially compressed. Often, these panels are then steamed or heat-molded in order to be sufficiently malleable to form desired shapes. Subsequently, the panels are heated in ovens or furnaces for extended periods of time to ensure proper lamination. Often, the extreme temperatures result in the burning of the exterior layers of the panels. In order to avoid such burning, the exposure times to these high temperatures are reduced. However, the reduction in time often does not allow proper melting and absorption of the adhesive disposed between the wooden sheets, often resulting in inferior lamination.

In order to overcome this dilemma, extended exposure time at relatively lower temperatures is required to properly laminate the wooden sheets. Furthermore, the panels, when properly heated, are adequately laminated but the panels also retain more heat. Therefore, extended cooling periods are required in order to safely handle the panels for processing. Unfortunately, extended heating and cooling times elongate the time period to manufacture these cases, thereby raising the cost of production.

Therefore, a new method of manufacturing a case, and in particular a case for musical instruments, is needed to overcome the deficiencies and disadvantages of the prior art.

### SUMMARY

The present invention is directed to a method for manufacturing a case and product thereof.

Additional features and advantages of the invention will be set forth in the description, or may be learned by practice of the invention. The objectives and other advantages of the invention will be realized and attained by the structure particularly pointed out in the written description and claims hereof as well as the appended drawings.

In accordance with one aspect of the invention, a method for manufacturing a case comprises the steps of: inserting an adhesive between a stack of sheets of a rigid material; compressing the stack of sheets; heat-molding the stack of sheets to form sidewalls and panels; and heating the stack of sheets using radio frequency radiation.

In some embodiments, the method may further comprise the steps trimming the stack of sheets to remove an excess of material; adhering the sidewalls to the panels, thereby forming an interior and exterior of the case; stapling the sidewalls to the panels; disposing a shock-absorbing material within the interior of the case; and fixing a fabric layer over the shock-absorbing material.

In some embodiments, the method may further comprise the step of disposing cover over the exterior of the case. Also in some embodiments, the method may further comprise the step of fixing a bracket to a corner formed by the junction of a sidewall to a panel. Such brackets may comprise approximately “L” shaped, polymer brackets. Some embodiments of the method may also further comprise wooden sheets which are arranged prior to stacking such that a grain pattern of each wooden sheet is approximately perpendicular to a grain pattern of an adjacent wooden sheet.

In accordance with one aspect of the invention, the shock-absorbing material comprises injection molded polyurethane foam. Also, the adhesive comprises latex glue.

A case for musical instruments according to one embodiment of the invention comprises a plurality of panels comprised of a plurality of layered wooden sheets, wherein an adhesive is inserted between each wooden sheet, and wherein the plurality of wooden sheets are compressed, heat-molded, and irradiated with radio waves. The case, having an interior and an exterior, also comprises one or more “L” shaped brackets disposed on one or more junctions of the plurality of panels. Further, the case comprises a molded shock-absorbing material disposed on an interior of the case, a fabric material disposed over the shock-absorbing material, and a protective cover disposed over an exterior of the case.

In accordance with aspect of an embodiment of the invention, the case may further comprise a plurality of staples to adhere the plurality of panels to each other. Furthermore, the case may further comprise one or more “L” shaped brackets disposed on one or more junctions of the plurality of panels.

### BRIEF DESCRIPTION OF THE DRAWINGS

The accompanying drawings, which are included to provide a further understanding of the invention and are incorporated in and constitute a part of this specification, illustrate an embodiment of the invention and together with the description serve to explain the principles of the invention.

FIG. 1 illustrates a flow diagram of a method of manufacturing a case in accordance with an embodiment of the invention; and

FIG. 2 illustrates a perspective view of an exemplary sheet arrangement for a case in accordance with an embodiment of the invention.

Features, elements, and aspects of the invention that are referenced by the same numerals in different figures represent the same, equivalent, or similar features, elements, or aspects in accordance with one or more embodiments. Reference will now be made in detail to one or more embodiments of the invention, examples of which are illustrated in the accompanying drawings.

### DETAILED DESCRIPTION OF THE PREFERRED EMBODIMENT

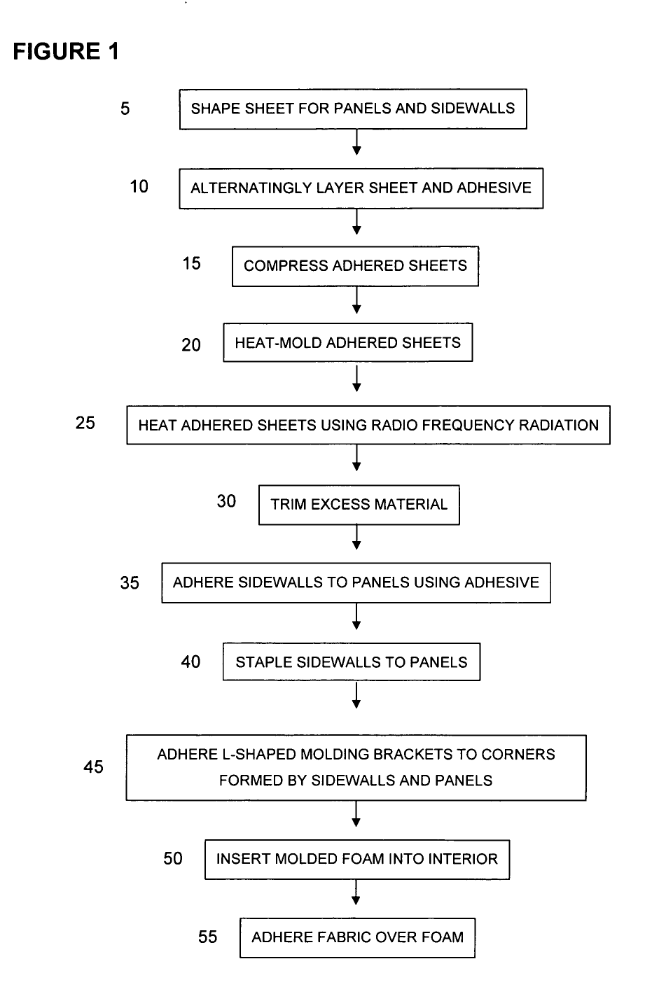

Referring to FIG. 1, a method for manufacturing a case in accordance with one or more embodiments is disclosed. Sheets comprising a rigid material are used to construct the panels and sidewalls of the case. Preferably, the rigid material is wood and each sheet is approximately 1 mm to 2 mm in thickness. For example, the wooden sheets may comprise compressed wood. Sheets of greater thickness or, alternatively, a greater number of sheets, can be used for larger, more rigid cases. Furthermore, the sheets may also comprise at least one of compressed paper, plywood, other natural and processed and woods, fiberglass, or any suitable sheet material known to one of ordinary skill in the art. In step 5, several sheets are shaped to form panels and sidewalls, wherein templates, stencils and the like may be used to form the shapes.

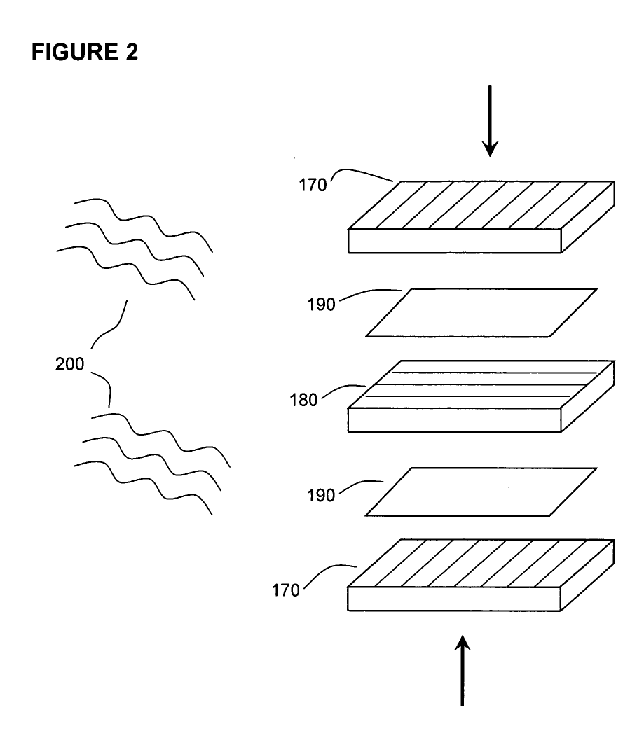

In step 10, the sheets are then alternatingly layered with adhesive disposed between the sheets. Preferably, the adhesive comprises latex glue, although other forms of glue, including animal glue, synthetic resins and the like can be used. Referring to FIG. 2, an exemplary arrangement of wooden sheets 170 and 180 and the adhesive 190 can be seen. Preferably, the wooden sheet 180 is arranged such that the grain pattern within the sheet 180, as indicated by the horizontal lines on the upper surface plane, is approximately perpendicular to the grain patterns within the wooden sheets 170, as indicated by the vertical lines on the upper surface planes. Subsequently, in step 15, the layers of sheets and adhesive are compressed, as indicated in FIG. 2 by the downwards and upwards directed arrows.

In step 20, the stack of adhered sheets is, for example, heat-molded using a dye or the like to obtain the final shape. The combination of heat and physical force render the stack sufficiently malleable to create the final shape of the panel or sidewall. For example, with respect to a case for a violin, a degree of concavity is required for the lid or base of the case in order to accommodate the instrument.

After heat-molding, the molded stack of sheets is then heated by using radio frequency radiation, as indicated in step 25. As shown in FIG. 2, radio waves 200 are utilized to heat the stack of adhered wooden sheets 170 and 180. Radio waves sufficiently warm the interior of the stack, including melting the adhesive 190 for proper absorption into the wooden sheets 170 and 180, without charring the exterior of the stack. Consequently, use of radio frequency radiation significantly decreases the amount of heating and cooling time required to handle and further process the now laminated sheets, thereby reducing manufacturing costs and time. In addition, radio frequency radiation requires less energy to effectively heat the stack of wooden sheets, further reducing manufacturing costs.

In step 30, the excess material that results from the molding step 20 is trimmed from the laminated panels and sidewalls. The sidewalls are then fastened to the panels. Referring to FIG. 1, the sidewalls are first adhered to the panels using an adhesive, such as latex glue, for example, in step 35. In step 40, the sidewalls are then stapled to the panels for additional structural rigidity. A case is eventually formed by engaging matching or corresponding panels, wherein hinges and latches, zippers and other fastening means well known in the art are disposed on the case.

For additional support, brackets are fastened to the corners created by the junction of the sidewalls to the panels, in step 45. Preferably, the brackets are approximately “L” shaped to fit the corners and comprise a polymer, for example. The brackets are preferably glued, using latex glue or the like, within the interior of the case, although the brackets can also be disposed on the exterior, as well. For larger cases, additional means of fastening can be used to further reinforce the brackets, such as “Chicago” screws, nuts and bolts, and other fasteners known to one of ordinary skill in the art.

In some embodiments, a shock absorbing material is disposed within the case to provide further protection to the eventual contents. In step 50, molded foam is inserted into the interior of the case. Preferably, injection-molded, polyurethane foam is utilized to provide maximum protection while minimizing material and manufacturing costs. In step 55, fabric is disposed over the foam to provide aesthetics and additional shock-absorbing protection. Preferably, the fabric is stretched over the foam and is adhered to the foam and the case, using glue, either alone or in combination with staples, for example. The fabric may be made of velvet or pile fabric, for example.

A protective cover is disposed over the exterior of the case (step not shown). Depending on its usage, the case may employ a ballistic nylon cover, for example, as used with most luggage containers. Alternatively, a rigid, plastic shell can be disposed over the case, which is preferably for individuals who check baggage when flying.

Although particular embodiments of the invention have been illustrated and described, it will be apparent to those skilled in the art that changes and modifications may be made without departing from the invention in its broader aspects, and therefore, the appended claims are to encompass within their scope all changes, modifications and equivalents that fall within the true scope of the invention.

1. A method for manufacturing a case, the method comprising:
inserting an adhesive between a stack of sheets comprising a rigid material;
compressing the stack of sheets;
heat-molding the stack of sheets to form sidewalls and panels for the case; and
heating the stack of sheets using radio frequency radiation.

2. The method of claim 1, further comprising the step of trimming the stack of sheets to remove an excess of material.

3. The method of claim 1, further comprising the step adhering the sidewalls to the panels, thereby forming an interior and an exterior for the case.

4. The method of claim 3, further comprising the step of stapling the sidewalls to the panels.

5. The method of claim 3, further comprising the step of disposing a shock-absorbing material within the interior of the case.

6. The method of claim 5, wherein the shock-absorbing material comprises injection molded polyurethane foam.

7. The method of claim 5, further comprising the step of fixing a fabric layer over the shock-absorbing material.

8. The method of claim 7, wherein the fabric material comprises velvet.

9. The method of claim 1, further comprising the step of disposing a cover over the exterior of the case.

10. The method of claim 9, wherein the cover comprises of ballistic nylon.

11. The method of claim 1, wherein the rigid material comprises wood.

12. The method of claim 11, further comprising the step of arranging the stack of sheets such that a wood grain pattern of a sheet is approximately perpendicular to a wood grain pattern of an adjacent sheet.

13. The method of claim 11, wherein a sheet has a thickness of approximately 1 mm to 2 mm.

14. The method of claim 1, wherein the adhesive comprises latex glue.

15. The method of claim 1, further comprising the step of fixing a bracket to a corner formed by junction of a sidewall to a panel.

16. The method of claim 15, wherein the bracket is approximately “L” shaped.

17. The method of claim 16, wherein the bracket comprises a polymer.

18. The method of claim 16, wherein the bracket is fixed on a corner formed on the exterior of the case.

19. The method of claim 16, wherein bracket is fixed on a corner formed on the interior of the case.

20. The method of claim 16, wherein the bracket is adhered to a corner using an adhesive.

21. The method of claim 16, wherein the bracket is fastened to a corner using a “Chicago” screw.

22. The method of claim 1, wherein the stack of sheets comprises compressed wood.

23. The method of claim 1, wherein the stack of sheets comprises compressed paper.

24. The method of claim 1, further comprising the step of shaping the stack of sheets prior to inserting the adhesive.

25. A case for musical instruments, the case having an interior and an exterior, comprising:
a plurality of panels comprised of a plurality of layered wooden sheets, wherein an adhesive is inserted between each wooden sheet, and wherein the plurality of wooden sheets are compressed, heat-molded, and irradiated with radio waves;
a molded shock-absorbing material disposed on an interior of the case;
a fabric layer disposed over the molded shock-absorbing material; and
a cover disposed over an exterior of the case.

26. The case of claim 25, further comprising a plurality of staples to adhere at least a first panel to a second panel of said plurality of panels.

27. The case of claim 26, further comprising at least one “L” shaped bracket disposed on a junction formed by the first and second panels.
